(19) United States
(12) Patent Application Publication
(10) Pub. No.: US 2022/0396008 A1
(43) Pub. Date: Dec. 15, 2022

(54) Novel Wood-Plastic Composite Material, Products, and Processes for Making Same

(71) Applicant: Joshua Allen McGuire, Lake Charles, LA (US)

(72) Inventor: Joshua Allen McGuire, Lake Charles, LA (US)

(21) Appl. No.: 17/827,511

(22) Filed: May 27, 2022

Related U.S. Application Data
(60) Provisional application No. 63/209,931, filed on Jun. 11, 2021.

(51) Int. Cl. B29B 15/10; B29B 13/02

(52) U.S. Cl. CPC B29B 15/10; B29B 13/02; B29K 2903/08; B29K 2401/00

(57) ABSTRACT

A manufacturing process for a material includes the steps of impregnating a predetermined amount of cellulose fibers with a predetermined amount of clay particulates, adding a predetermined amount of plastic, applying high heat to carbonize the combined materials and manipulating the combined materials while applying heat, and forming the carbonized combined materials by one of extrusion, casting, stamping, and as a 3-D printing filament

### RELATED APPLICATION

The present application claims the benefit of U.S. Provisional Patent Application No. 63/209931 filed on Jun. 11, 2021, the entirety of which is incorporated herein by reference.

### FIELD

The present disclosure relates to novel wood-plastic composite materials, products, and processes for making same.

### BACKGROUND

Spurred on by the COVID-19 pandemic and high demands, lumber prices have surged in 2020 and 2021. Between April 2020 and April 2021, the National Association of Home Builders (NAHB) estimated that price per thousand board feet increased by nearly 250%—from $350 to $1,200. Prices then soared past $1,400 in early May and have continued increasing since. The high lumber costs have increased the price of a single-family home by about $36,000 according to the NAHB.

Invented in the late 1980s, wood-plastic composite decking materials sold under the brand name TREX is made of wood fibers encased in plastic. The existing wood-plastic composite materials are advantageous over lumber in terms of durability, low maintenance requirements, and performance.

### BRIEF DESCRIPTION OF THE DRAWINGS

FIG. 1 is a flowchart of an exemplary embodiment of a manufacturing process of a low-cost lightweight wood-plastic material according to the teachings of the present disclosure; and

FIGS. 2-6 are various views of exemplary embodiments of producing a processed cellulose fiber material as an ingredient for the novel wood-plastic material according to the teachings of the present disclosure.

### DETAILED DESCRIPTION

Existing wood-plastic composite material such as TREX are fabricated from a mix of recycled wood fibers and plastics to manufacture the core of each decking board. A combination of sawdust and ground-up wood from sawmills and furniture factories, along with recycled plastics from milk jugs and grocery bags are traditional used as the source material. The core is then capped with a polymer outer layer, which is a durable plastic protective shell that resists mold, staining, and fading.

The present disclosure describes an improved wood-plastic composite material that is low cost, lightweight, high impact, and high load capacity. This novel lightweight recycled wood-plastic composite material can be used in construction and to fabricate building components. The wood-plastic composite material produces a building component that is also thermally insulative and fire-retardant. The proposed wood-plastic composite material may be used to create building components such as bricks, blocks, panels (i.e., oriented strand board and plywood substitutes), posts, columns, beams, foundations, walls, and other types of structural components and supports. The wood-plastic composite material can be molded, cast, extruded, stamped, and as a 3-D printing filament to create building components, as well as components for other applications such as, for example, automotive parts and electric appliance housings. The resultant product is lightweight, insulative, fire-retardant, and has higher strength to weight ratio that also substantially reduces costs and offset the carbon footprint of construction projects.

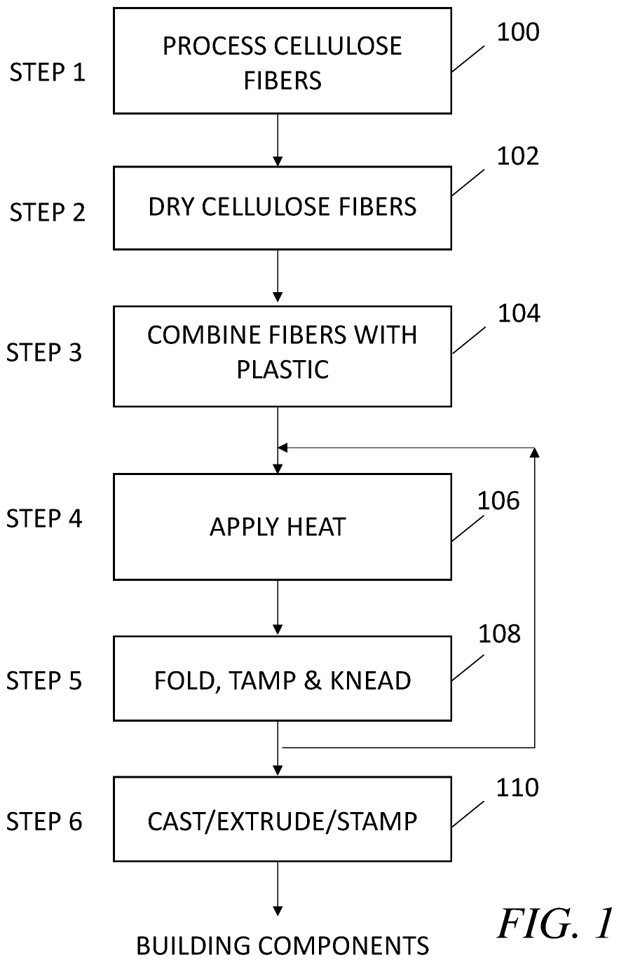

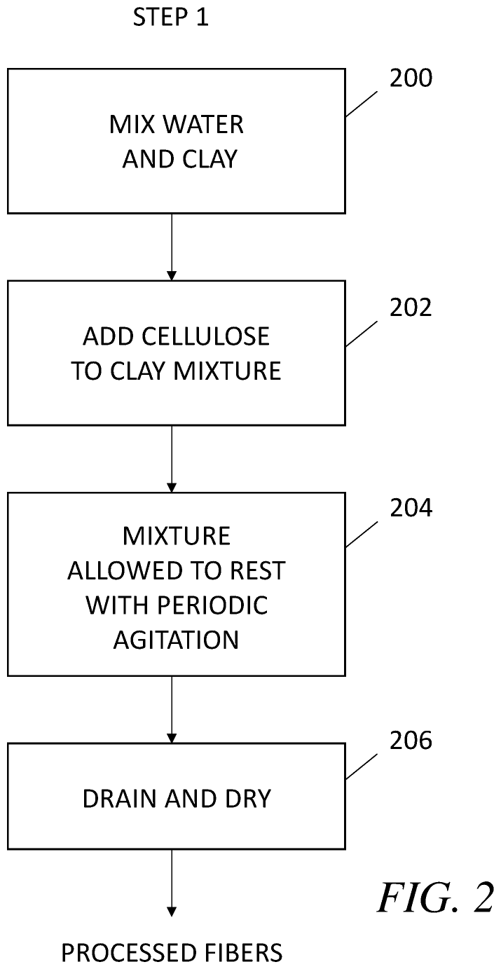

Referring to FIG. 1, the fabrication method has six main steps (blocks 100-110): processing the organic cellulose material, which is an organic cellulose material of certain sizes, including sawdust, wood chips, wood flakes, wood strips, fiber, bamboo, hemp, burlap, tweed, organic waste, and animal waste both in liquid and solid form. In a preferred embodiment, the source of the cellulose material is saw dust or fibers from sawmills. Several embodiments of processing the cellulose fibers are disclosed herein (FIGS. 2-6) including several methods of combining or impregnating clay particulates into the cellulose fibers. This step may be performed by mixing all of the ingredients together with periodic agitation, but a preferred method is to add the cellulose material and other ingredients into a hopper and allow the materials to pass through an extruder. The fin configuration of the screw and the barrel length of the extruder may be factors that determine the sizing and other characteristics of the end product. The next step (step 2 102) is to dry the processed cellulose fibers. At the end of the second step, an “AGGREGREAT” (aggregate) mix product is produced. The third step 104 is to combine and mix the novel aggregate product, which is processed cellulose fibers, with plastic. The weight ratio of dry wood fibers and plastic can be, for example, 1:1, 1:2, 2:1, 2:3, 3:2, or 55:50. Preferably, the plastic material used in this process is recycled plastic materials, such as single-use grocery bags made from polyethylene. The plastic material may be unprocessed plastic bags, or in pellet form, shredded, sheets, and any other suitable form. In the 4th and 5th steps 106 and 108, high heat is applied to the cellulose and plastic material to carbonize the materials while the materials are manipulated. For example, heat from a propane blow torch (3600 degrees Fahrenheit) may be used to melt and burn the materials, while the materials are folded, tamped, and kneaded together so that the materials are combined. Alternatively, heat in the range of 200-400 degrees Fahrenheit may be used during steps 4 and 5 to meld and combine the processed cellulose and plastic materials. The resultant carbonized wood-plastic composite material is soft enough to be formed by casting with a mold, extruded, stamped, or as a 3-D printing filament into the desired proper shapes and sizes, step 6 110.

FIG. 2 is a simplified flowchart of a manufacturing process for a cellulose-based aggregate product that is used as the processed cellulose fibers in FIG. 1. The lightweight admix and aggregate can be made by first combining by folding and mixing a light fine clay, and water (at a certain predetermined temperature), as shown in block 200. This clay mixture is then combined with an organic cellulose material of certain sizes with periodic agitation, as shown in blocks 202 and 204. The ratios of the three main components (cellulose material, water, and fine clay) can be varied dependent on the desired characteristics of the final product. Saw dust is a desirable material to use as it is a waste product of the lumber industry. Green cellulose can be air dried or dried with an application of heat (e.g., in a kiln) to remove excess moisture. The cellulose, clay, and water can be mixed together using a paddle mixer to ensure that the cellulose is well-hydrated, the clay particles are well-dispersed in the mixture (emulsification), and the cellulose fibers are well-coated with the clay emulsification. Alternatively, the clay, water, and sawdust/cellulose can be added and combined at the same time. This causes the fine clay particles and minerals present in the clay to be impregnated in the cellulose, filling voids between the fibers and particles. The cellulose-water-clay mixture is then allowed to stand, with periodic mixing or agitation, for a time period, such as a number of hours. Then the mixture is poured out and evenly spread over a flat and water permeable surface that allows moisture to be drained and removed from the cellulose-clay mixture, as shown in block 206. A tumbling barrel with water-permeable sides may be used to remove the moisture, with or without added heat and/or air movement. The treated cellulose can be air dried this way, or an application of heat at a certain temperature with or without forced air and/or vacuum may be used to speed up the process. The amount of clay present in the mixture can be increased to increase the compressive strength, depending on the desired characteristics of the end product. The dried cellulose-based admix is composed of cellulose thoroughly coated and impregnated with fine clay particles and minerals. The result is an admix product that can be used in both Portland cement and thermoplastic mixtures that produces a lightweight but strong construction material.

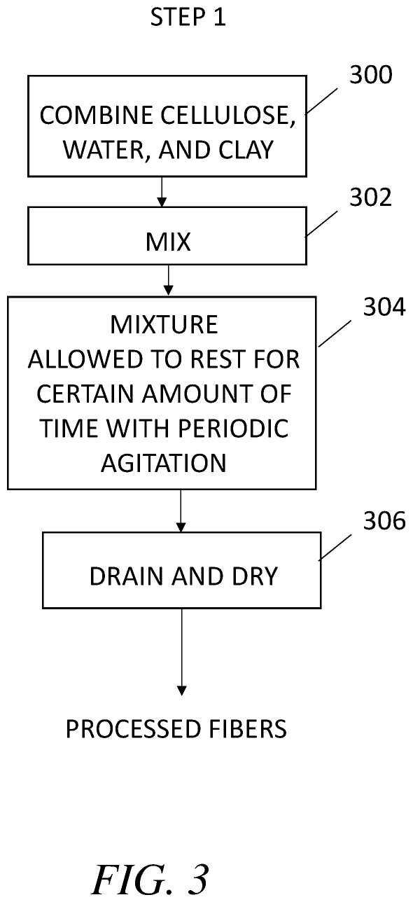

Referring to blocks 300-306 in FIG. 3, an alternative manufacturing process mixes cellulose, clay, and water at a predetermined ratio and temperature. The mixture is then allowed to soak and rest, with optional periodic agitation. The mixture is then allowed to drain and be dried. Heat, forced air circulation, and/or vacuum may be used during the drying process.

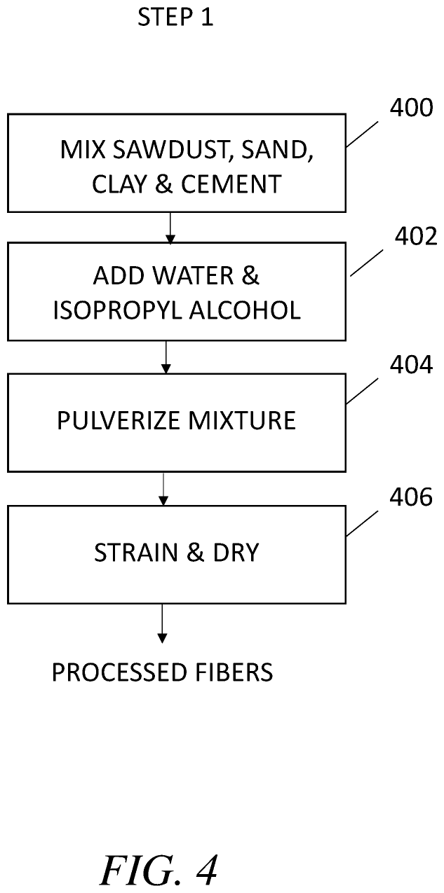

FIG. 4 is a flowchart that provides another embodiment of the STEP 1 process for creating the processed cellulose fibers. Cellulose materials in the form of sawdust or other organic materials are mixed with a combination of sand and clay, or a combination of sand, clay, and Portland cement, as shown in block 400. An example ratio of these materials may be one part sand to 1.5 part sawdust. An appropriate amount of water and an appropriate amount of isopropyl alcohol are added to the dry mix, as shown in block 402. The combined mixture is then blended and pulverized so that the cellulose fibers are a certain desired size, as shown in block 404. The end product is then strained and dried, as shown in block 406. The resultant product is a dry processed fiber mix.

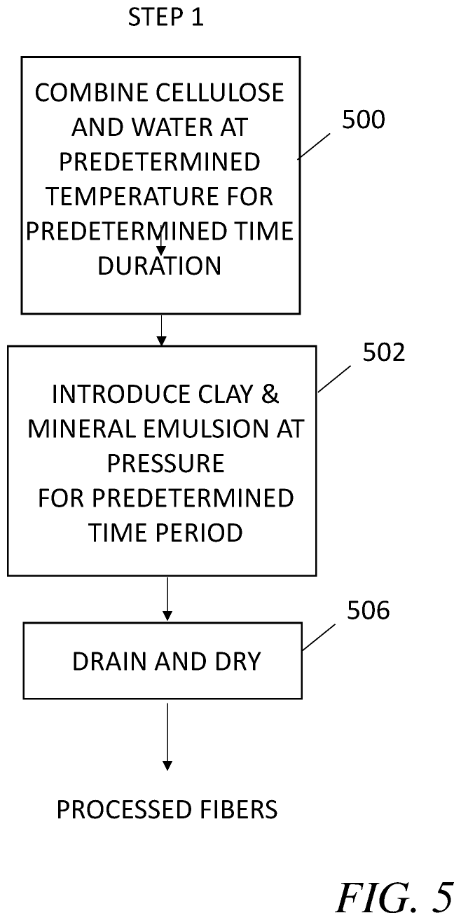

FIG. 5 is a flowchart that provides yet another embodiment of the STEP 1 process for creating the processed cellulose fibers for fabricating the wood-plastic composite material. Cellulose materials in the form of sawdust or other organic materials are mixed with water at a certain temperature for a certain period of time to thoroughly hydrate the cellulose material, as shown in block 500. A clay emulsion is then introduced to the hydrated cellulose materials, which may be mixed to ensure thorough mixing, as shown in block 502. The clay emulsion includes clay, water, and optionally mineral particulates. The end product is then strained and dried, as shown in block 506. The resultant product is a dry processed fiber mix.

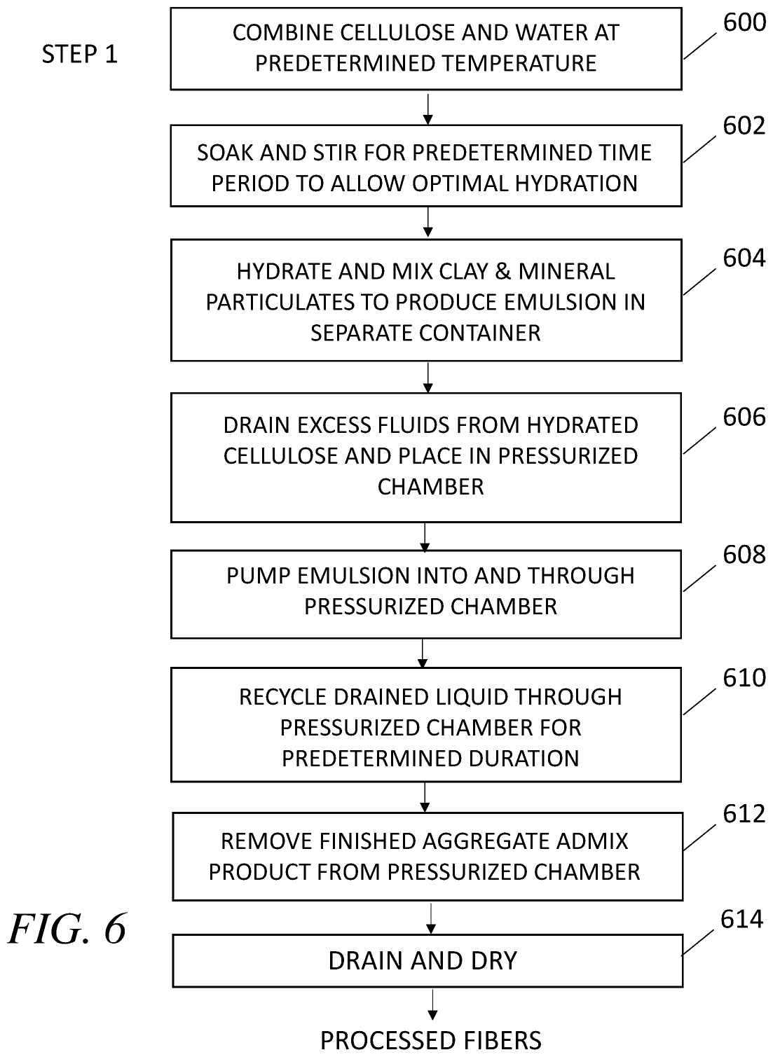

Referring to FIG. 6, yet another exemplary process begins with optimally soaking the cellulose fiber/sawdust using a liquid such as water at a predetermined temperature, as shown in blocks 600 and 602. In a separate container, a clay (with optionally mineral particulate) mixture is hydrated and mixed to produce an emulsion, as shown in block 604. Once fiber optimal hydration has been reached and the hydration-swollen fiber has been flushed of the sugar or sap, excess liquids are drained and the hydrated fibers are placed in a pressurized chamber, as shown in block 606. The clay/mineral emulsification is then introduced by pumping it into and through the pressurized chamber, as shown in block 608. The liquid that drains from the pressurized chamber is recycled back through the chamber, as shown in block 610. The duration that the fibers are exposed to the emulsion along with the pressures of pressurized chamber has a direct correlation to the level of penetration (coating/impregnation/stacking) of clay particulate/sediment into the cellulose fiber. The duration and pump pressure upon the fiber may be modified to allow for different aggregate admix performance characteristics and different levels of fiber density. Once this impregnation process is completed the result is the aggregate admix product, which may be removed and immediately utilized as an ingredient in the production of the wood-plastic composite, as shown in block 612. The processed fiber, now in aggregate admix form, may optionally be air/machine dried and bagged or placed in silos or shipping containers to allow for easier transport and distribution, as shown in block 614.

It should be noted that the plastic material disclosed herein may include polyethylene terephthalate (PETE or PET), polyethylene (PE), high density polyethylene (HDPE), low density polyethylene (LDPE), linear low density polyethylene (LLDPE), polyvinyl chloride (PVC), polypropylene (PP), polystyrene (PS), polylactic acid (PLA), polycarbonate (PC), acrylic (PMMA), acetal (Polyoxymethylene, POM), nylon/polyamide (PA), acrylonitrile butadiene styrene (ABS), polyoxymethylenes, polybutylene terephthalates (PBT), chlorinated polyvinyl chloride (CPVC); semi-rigid polyvinyl chloride (S-RPVC), etc.

Additional additive materials that can be added at one or more steps of the processes include clay, Portland cement, ceramics, graphene, metallic particulates, semi-metallic particulates, diatomaceous earth, crystalline expander, carbon-based materials, sand, silt, peat, loam, chalk, fly ash, recycled paper, phosphate, lime, calcium, magnesium, sugars, lignin, vegetable and animal proteins, cotton, almond flour, coconut flour, buckwheat flour, teff flour, quinoa flour, corn flour, wheat flour, barley flour, rice flour, rye flour, tree sap, syrup, sugars, tars, nut shells and husks, corn husks, grass clippings, any by product from the production of rice, wheat, and other grain, ethylene glycol derivatives, ionic water, salt, acids, alkaline, alcohol, bleach, and biodegradable surfactants (including H2), polyurethane (isocyanates); phenolic resin; epoxy resin; or unsaturated polyester.

The features of the present invention which are believed to be novel are set forth below with particularity in the appended claims. However, modifications, variations, and changes to the exemplary embodiments of the novel wood-plastic composite material and process for fabricating low cost, lightweight, high impact, high load capacity, and fire-retardant materials described above will be apparent to those skilled in the art, and the described herein thus encompasses such modifications, variations, and changes and are not limited to the specific embodiments described herein.

What is claimed is:

1. A material comprising a cellulose material and clay combined with a molten plastic material at a normal operating range.

2. The material of claim 1 further comprising cement combined with the cellulose material, clay and molten plastic material.

3. The material of claim 1, wherein the cellulose material is impregnated with clay particulates.

4. The material of claim 1, wherein the cellulose material comprises a carbonized cellulose material impregnated with clay and the molten plastic material comprises a carbonized plastic material.

5. A manufacturing process for a material comprising the steps of:
impregnating a predetermined amount of cellulose fibers with a predetermined amount of clay particulates;
adding a predetermined amount of plastic;
applying high heat to carbonize the combined materials and manipulating the combined materials while applying heat; and
forming the carbonized combined materials by one of extrusion, casting, stamping, and as a 3-D printing filament.

6. The manufacturing process of claim 5, wherein adding a predetermined amount of plastic comprises adding a predetermined amount of recycled plastic grocery bags.

7. The manufacturing process of claim 5, wherein impregnating a predetermined amount of cellulose fibers with a predetermined amount of clay particulates comprises combining a predetermined amount of a material selected from the group consisting of sawdust, wood chips, wood flakes, wood strips, fiber, bamboo, hemp, burlap, tweed, organic waste, and animal waste with a predetermined amount of clay particulates.

8. The manufacturing process of claim 5, further comprising the step of adding at least one additive selected from the group consisting of clay, ceramics, graphene, metallic particulates, semi-metallic particulates, diatomaceous earth, crystalline expander, carbon-based materials, sand, silt, peat, loam, chalk, fly ash, recycled paper, phosphate, lime, calcium, magnesium, sugars, lignin, vegetable and animal proteins, cotton, almond flour, coconut flour, buckwheat flour, teff flour, quinoa flour, corn flour, wheat flour, barley flour, rice flour, rye flour, tree sap, syrup, sugars, tars, nut shells and husks, corn husks, grass clippings, any by product from the production of rice, wheat, and other grain, ethylene glycol derivatives, ionic water, salt, acids, alkaline, alcohol, bleach, and biodegradable surfactants.

9. The manufacturing process of claim 5, wherein adding a predetermined amount of plastic comprises adding a material selected from the group consisting of polyethylene terephthalate (PETE or PET), polyethylene (PE), high density polyethylene (HDPE), low density polyethylene (LDPE), linear low density polyethylene (LLDPE), polyvinyl chloride (PVC), polypropylene (PP), polystyrene (PS), polylactic acid (PLA), polycarbonate (PC), acrylic (PMMA), acetal (Polyoxymethylene, POM), nylon/polyamide (PA), acrylonitrile butadiene styrene (ABS), polyoxymethylenes, polybutylene terephthalates (PBT), chlorinated polyvinyl chloride (CPVC), semi-rigid polyvinyl chloride (S-RPVC).

10. The manufacturing process of claim 5, wherein forming the carbonized combined materials comprises forming the carbonized combined materials to create wood substitute construction components selected from the group consisting of bricks, blocks, siding, shingles, panels, posts, columns, beams, foundations, and walls.

11. The manufacturing process of claim 5, wherein impregnating a predetermined amount of cellulose fibers with a predetermined amount of clay particulates comprises passing the cellulose fibers and clay through an extruder.

12. A manufacturing process for a wood substitute material comprising the steps of:
combining and mixing a predetermined amount of cellulose fibers selected from the group consisting of sawdust, wood chips, wood flakes, wood strips, fiber, bamboo, hemp, burlap, tweed, organic waste, and animal waste with a predetermined amount of clay particulates with a predetermined amount of clay particulates;
adding a predetermined amount of plastic;
applying high heat to carbonize the combined cellulose fibers, clay, and plastic materials and manipulating the combined materials while applying heat; and
forming the carbonized combined materials by one of extrusion, casting, stamping, and as a 3-D printing filament.

13. The manufacturing process of claim 12, wherein adding a predetermined amount of plastic comprises adding a predetermined amount of recycled plastic grocery bags.

14. The manufacturing process of claim 12, further comprising the step of adding at least one additive selected from the group consisting of clay, ceramics, graphene, metallic particulates, semi-metallic particulates, diatomaceous earth, crystalline expander, carbon-based materials, sand, silt, peat, loam, chalk, fly ash, recycled paper, phosphate, lime, calcium, magnesium, sugars, lignin, vegetable and animal proteins, cotton, almond flour, coconut flour, buckwheat flour, teff flour, quinoa flour, corn flour, wheat flour, barley flour, rice flour, rye flour, tree sap, syrup, sugars, tars, nut shells and husks, corn husks, grass clippings, any by product from the production of rice, wheat, and other grain, ethylene glycol derivatives, ionic water, salt, acids, alkaline, alcohol, bleach, and biodegradable surfactants.

15. The manufacturing process of claim 12, wherein adding a predetermined amount of plastic comprises adding a material selected from the group consisting of polyethylene terephthalate (PETE or PET), polyethylene (PE), high density polyethylene (HDPE), low density polyethylene (LDPE), linear low density polyethylene (LLDPE), polyvinyl chloride (PVC), polypropylene (PP), polystyrene (PS), polylactic acid (PLA), polycarbonate (PC), acrylic (PMMA), acetal (Polyoxymethylene, POM), nylon/polyamide (PA), acrylonitrile butadiene styrene (ABS), polyoxymethylenes, polybutylene terephthalates (PBT), chlorinated polyvinyl chloride (CPVC), semi-rigid polyvinyl chloride (S-RPVC).

16. The manufacturing process of claim 12, wherein forming the carbonized combined materials comprises forming the carbonized combined materials to create construction components selected from the group consisting of bricks, blocks, siding, shingles, panels, posts, columns, beams, foundations, and walls.

17. The manufacturing process of claim 12, wherein combining and mixing the cellulose fibers with the clay particulates comprises passing the cellulose fibers and clay through an extruder.
